(19) United States
(12) Patent Application Publication
(10) Pub. No.: US 2009/0327083 A1
(43) Pub. Date: Dec. 31, 2009

(54) AUTOMATING ON-LINE ADVERTISEMENT PLACEMENT OPTIMIZATION

(75) Inventors: Ashvin J. Mathew, Kirkland, WA (US); Max Chickering, Bellevue, WA (US); Jesper B. Lind, Bellevue, WA (US); Vadims Cugunovs, Redmond, WA (US); Dipanjan Ghosh, Redmond, WA (US); Xiaoqiao Li, Issaquah, WA (US); Nathan W. Brixius, Seattle, WA (US)

Correspondence Address: PERKINS COIE LLP/MSFT, P. O. BOX 1247, SEATTLE, WA, 98111-1247, US

(73) Assignee: Microsoft Corporation, Redmond, WA (US)

(21) Appl. No.: 12/163,861

(22) Filed: Jun. 27, 2008

(51) Int. Cl. G06Q 30/00

(52) U.S. Cl. 705/14.69

(57) ABSTRACT

A method and system for generating a price landscape for an advertiser for bids placed by the advertiser for advertisement space is provided. A price landscape system generates a price landscape based on information provided by an advertisement placement service that may include overall price estimation data and advertiser-specific performance data. The price landscape system generates price landscape data for an advertiser that combines the overall price estimation data and the advertiser-specific performance data to provide a more accurate assessment of the advertiser's expected performance than can be determined from the overall price estimation data or the advertiser-specific performance data alone.

### BACKGROUND

Many search engine services, such as Google and Live Search, provide for searching for information that is accessible via the Internet. These search engine services allow users to search for web pages and other Internet-accessible resources that may be of interest to users. After a user submits a search request that includes search terms, a search engine service identifies web pages that may be related to those search terms. To quickly identify related web pages, the search engine services may maintain a mapping of keywords to web pages. This mapping may be generated by “crawling” the web (i.e., the World Wide Web) to identify the keywords of each web page. To crawl the web, a search engine service may use a list of root web pages to identify all web pages that are accessible through those root web pages. The keywords of any particular web page can be identified using various well-known information retrieval techniques, such as identifying the words of a headline, the words supplied in the metadata of the web page, the words that are highlighted, and so on. When a search engine service receives a search request that includes one or more search terms, it uses its mapping to identify those information sources (e.g., web pages) whose keywords most closely match the search terms. The collection of information sources that most closely matches the search terms is referred to as the “search result.” The search engine service then ranks the information sources of the search result based on the closeness of each match, web page importance (e.g., Google's page ranking), and so on. The search engine service then displays to the user links to those information sources in an order that is based on their rankings.

Some search engine services do not charge a fee to the providers of web pages for including links to their web pages in search results. Rather, the search engine services obtain revenue by placing advertisement, along with search results. These paid-for advertisements are commonly referred to as “sponsored links,” “sponsored matches,” or “paid-for search results.” A vendor who wants to place an advertisement along with certain search results provides a search engine service with an advertisement and search terms (e.g., keywords). When a search request is received, the search engine service identifies the advertisements whose search terms match those of the search request. The search engine service then may display some of the advertisements along with the search results. If more advertisements are identified than will fit on the first page of the search results, the search engine service may select to display on the first page advertisements based on some criterion such as bid amount. In general, a search engine service or other advertisement placement service will display advertisements with higher metric score more prominently. The metric score may be a function of bid amount, clickthrough rate of one advertiser, and so on. For example, a list of sponsored links may be ordered by this metric, the advertisement with the highest metric may be displayed in a prominent location (e.g., top of a web page), an advertisement with a high bid amount may be highlighted, and so on. Thus, the higher an advertiser bids the more prominently the advertiser's advertisements are displayed. The search engine services can either charge for placement of each advertisement along with search results (i.e., cost per impression) or charge only when a user actually selects a link associated with an advertisement (i.e., cost per click).

To maximize the effectiveness of their advertising dollars, advertisers may use various techniques to determine the bid amount for a particular keyword. An advertiser may want to place an advertisement in a less prominent position on the first page of a search result, rather than a more prominent position on the first page, under the assumption that the additional cost for the more prominent position outweighs its benefit. If the advertisement is placed in a more prominent position, then the advertiser is bidding too much and the advertiser's advertising expenses will increase. In contrast, if the advertisement is placed on the second page, rather than the first page, the advertiser might not be bidding high enough. In such a case, because only a few users may actually see and select the advertisement, the advertiser may lose profitable sales that might have been made if the bid amount had been only slightly higher.

Some advertisers may use an Enterprise Resource Planning (ERP) system that integrates most of the data and processes of the advertiser's business into a unified system. A typical ERP system uses multiple components of computer software and hardware to achieve the integration. Most ERP systems use a unified database to store data for the various system components. Prior to using an ERP system, most organizations have separate applications for accounting, human resources, and other business functions, with external interfaces between each application for sharing data between applications. The introduction of an ERP system to replace two or more independent applications eliminates the need for external interfaces previously required between these applications and provides additional benefits that range from standardization and lower maintenance (one system instead of two or more) to easier reporting and greater reporting capabilities (as all data is typically kept in one database). ERP systems typically attempt to cover all basic functions of an organization, regardless of the organization's business or charter. For example, ERP systems may cover advertising, manufacturing, warehousing, logistics, information technology, accounting, human resources, marketing, payroll, and strategic management. Some ERP systems may allow an organization to place online advertisements with advertisement placement services. The ERP system allows advertisers to specify advertisements, keywords, and bid amounts for various advertising campaigns. The keywords and bid amounts can be derived in part from the data stored by the ERP system. Businesses, nonprofit organizations, nongovernmental organizations, governments, and other organizations utilize ERP systems.

Different advertisers use different metrics to measure the success of their advertising campaigns. One metric is “conversion.” A purchase conversion generally refers to placement of an advertisement that results in an actual sale of product. For example, a purchase conversion occurs when a user who sees an advertisement for a computer clicks on the advertisement and subsequently purchases the computer. Other types of conversions may be possible. For example, an organization may place advertisements to generate leads for their sales force. An example of such an organization may be a real estate brokerage. The brokerage may place advertisements offering their real estate services. When the placement of an advertisement generates a lead, a real estate agent may call the person identified by the lead to determine whether person is really interested in and qualified to participate in a real estate transaction. Once the agent is confident that the person is interested and qualified, the agent may designate the lead as a “qualified lead.” The brokerage may judge the success of an advertising campaign based on the cost per qualified lead, the number of qualified leads, the profit resulting from the advertising campaign, and so on.

The profitability of many organizations depends in large part on the success of their online advertising campaigns. Such organizations seek to select the best combinations of advertisements, bid amounts, keywords, and so on that will maximize their profitability or maximize the chance that they will reach some other objective (e.g., number of donations to a charity).

### SUMMARY

A method and system for generating a price landscape for an advertiser for bids placed by the advertiser for advertisement space is provided. In some embodiments, a price landscape system generates a price landscape based on information provided by an advertisement placement service that may include overall price estimation data and advertiser-specific performance data. The overall price estimation data may indicate what the advertisement placement service estimates will be the overall price for advertisements placed with certain keyword and bid amount combinations for a specific day. The advertiser-specific performance data provides information that is specific to each advertiser. The price landscape system generates price landscape data for an advertiser that combines the overall price estimation data and the advertiser-specific performance data to provide a more accurate assessment of the advertiser's expected performance than can be determined from the overall price estimation data or the advertiser-specific performance data alone.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

FIG. 1 is a block diagram that illustrates components of a price landscape system in some embodiments.

FIG. 2 is a flow diagram that illustrates the processing of a populate price landscape table component in some embodiments.

FIG. 3 is a flow diagram that illustrates the processing of a calculate overall clickthrough rate component in some embodiments.

FIG. 4 is a flow diagram that illustrates the processing of a calculate overall cost per click component in some embodiments.

FIG. 5 is a flow diagram that illustrates the processing of a calculate advertiser-specific clickthrough rate component in some embodiments.

FIG. 6 is a flow diagram that illustrates the processing of a calculate advertiser-specific cost per click component in some embodiments.

FIG. 7 is a flow diagram that illustrates the processing of a calculate price landscape data component in some embodiments.

FIG. 8 is a flow diagram that illustrates the processing of a suggest bids component in some embodiments.

FIG. 9 is a flow diagram that illustrates the processing of a solve for bids component in some embodiments.

### DETAILED DESCRIPTION

A method and system for generating a price landscape for an advertiser for bids placed by the advertiser for advertisement space is provided. In some embodiments, a price landscape system generates a price landscape based on information provided by an advertisement placement service that may include overall price estimation data and advertiser-specific performance data. The overall price estimation data may indicate what the advertisement placement service estimates will be the overall price for advertisements placed with certain keyword and bid amount combinations for a specific day. Each advertisement placement service may use different algorithms and assumptions when generating such overall price estimation data. The overall price estimation data may provide a good overall estimate since it may be generated based on the performance of all advertisers. However, since the actual performance of individual advertisers can vary dramatically from each other and from the overall averages for various reasons such as poor choice of keywords, bid amounts, advertisement content, and so on, the overall price estimation data may not accurately represent an individual advertiser's performance. The advertiser-specific performance data, in contrast, provides information that is specific to each advertiser. The advertiser-specific performance data may include for each keyword of the advertiser the number of impressions, average advertising position, total cost, and so on. The advertiser-specific performance data, however, may be sparse because the number of advertisements placed for each advertiser may only be a very small percentage of the total number of advertisements placed by an advertisement placement service. The advertiser-specific performance data may also not provide as much detail as the overall price estimation data. For example, the advertiser-specific performance data may not report separately on the performance for each different advertisement position. The price landscape system generates price landscape data for an advertiser that combines the overall price estimation data and the advertiser-specific performance data to provide a more accurate assessment of the advertiser's expected performance than can be determined from the overall price estimation data or the advertiser-specific performance data alone.

In some embodiments, the overall price estimation data may be provided by an advertisement placement service on a daily basis and include, for various combinations of keyword, advertisement position, and bid amount, the estimated number of clicks, the estimated total cost, and the estimated number of impressions. For example, the overall price estimation data may be stored in a table that includes a row for the keyword of “computer,” the bid amount of $0.25, and the advertisement position of 1 indicating 100 impressions, 10 clicks, and the cost of $2.50. The table may include another row for the keyword of “computer,” the bid amount of $0.10, and the advertisement position of 2 indicating 100 impressions, 10 clicks, and the cost of $1.00. Such overall price estimation data may indicate that an advertiser in general would be better off bidding $0.10 rather than $0.25 since the clickthrough rates are comparable, but the cost per click with a $0.10 bid amount is much less. An individual advertiser, however, may get very poor performance when its advertisement is in the advertisement position of 2, because a competitor may be bidding slightly more and may have a much effective advertisement.

In some embodiments, the advertiser-specific performance data may be provided by an advertisement placement service to each advertiser on a daily basis reporting on the advertiser's performance for the previous day. The advertiser-specific performance data may indicate for each campaign of the advertiser statistics for each keyword of the campaign. Each row of an advertiser-specific performance data table may identify the keyword and indicate average advertisement position, number of impressions, number of clicks, number of conversions, total cost, conversion rate, and so on. As discussed above, the advertiser-specific performance data may be sparse and not as detailed as the overall price estimation data.

In some embodiments, the price landscape system generates price landscape data that is specific to an advertiser by combining the overall price estimation data and the advertiser-specific performance data. For each keyword and advertisement position combination, the price landscape data may include estimates for a clickthrough rate for the keyword, a cost per click for the keyword, the number for impressions for the keyword, and conversions per click for the keyword. The price landscape system analyzes the overall price estimation data and the advertiser-specific performance data collected over many clays to generate a function to map the overall price estimation data to the advertiser-specific performance data of an advertiser. The price landscape system uses a curve-fitting approach to generate the function. As described below, the price landscape system uses a weighted least-squares approach (e.g., using a decay factor) to de-emphasize older data. The price landscape system generates curves for the clickthrough rate and the cost per click for each advertisement position for each keyword and then generates the price landscape data based on those curves.

To generate the curves for the clickthrough rate, the price landscape system calculates an overall pre-position clickthrough rate based on the overall price estimation data. The price landscape system calculates an overall clickthrough rate CTR_{PE} (pos) from the overall price estimation data for each keyword and advertisement position (“pos”) combination. The advertisement positions may be 1 through 8 depending on the number of advertisement positions made available by an advertisement placement service. To calculate the overall clickthrough rate, the price landscape system divides the total number of clicks by the total number of impressions for a keyword and advertisement position combination. If the advertisement positions are presented as fractions (e.g., 4.5 or 6.1) in the overall price estimation data, then the price landscape system estimates the overall clickthrough rate for an integral advertisement position (e.g., 5) based on the overall price estimation data for nearby fractional advertisement positions (e.g., 4.5 and 6.1). One skilled in the art will appreciate that other algorithms may be used to calculate clickthrough rate such as algorithms based on informative or uninformative information. If the overall price estimation data does not include data for a certain keyword, the price landscape system may estimate an overall clickthrough rate based on an aggregate of the total number of clicks and impressions for that keyword in the advertiser-specific performance data. The price landscape system may also calculate an overall cost per click CPC_{PE} (pos) in a similar manner.

The price landscape system generates an advertiser-specific clickthrough rate CTR_{A} (pos) function and a cost per click CPC_{A} function for each keyword by curve-fitting the overall price estimation data to the advertiser-specific performance data. The function for the advertiser-specific clickthrough rate may be represented by the following equation:

CTR_{A}(pos)=min(γ+αCTR_{PE}(pos),0) (1)

where γ and α represent parameters calculated using a weighted least-squares fit between the overall price estimation data and the advertiser-specific performance data. The price landscape system calculates the parameters using the values defined in the following equations:

$$M = {\sum }_{DAY = 1}^{n} {κ}^{n - DAY} \times IM ( DAY ) \\ C = {\sum }_{DAY = 1}^{n} {κ}^{n - DAY} \times IM ( DAY ) \times CTR ( DAY ) \\ P = {\sum }_{DAY = 1}^{n} {κ}^{n - DAY} \times IM ( DAY ) \times PECTR ( DAY ) \\ Q = {\sum }_{DAY = 1}^{n} {κ}^{n - DAY} \times IM ( DAY ) \times PECTR ( DAY ) \times PECTR ( DAY ) \\ R = {\sum }_{DAY = 1}^{n} {κ}^{n - DAY} \times IM ( DAY ) \times PECTR ( DAY ) \times CTR ( DAY ) \qquad ( 2 )$$

where IM(DAY) represents the observed number of impressions for the day DAY, CTR(DAY) represents the clickthrough rate or DAY, PECTR(DAY) represents the CTR_{PE} from the overall price estimation data, n represents the number of days of data, and κ represents the decay factor. The price landscape system sets the parameters as represented by the following equations:

$$\begin{matrix}γ = \frac{C \times Q - R \times P}{M \times Q - P \times P} & ( 3 ) \\ α = \frac{- C \times P + M \times R}{M \times Q - P \times P} & ( 4 )\end{matrix}$$

The function for the advertiser-specific cost per click for a keyword may be represented by the following equation:

CPC_{A}(pos)=min(θ+βCPC_{PE}(pos),0) (5)

where θ and β represent parameters calculated using a weighted least-squares fit from the data in a manner similar to that described for the clickthrough rate.

The price landscape system also estimates an advertiser-specific number of impressions for each advertisement position IM(pos) for each keyword. In some embodiments, the price landscape system assumes that the function representing impressions for the positions has the shape of a sigmoid function. The price landscape system calculates the root mean square error of all data points for different sigmoid functions that are each centered around one of the positions. The price landscape system then selects the sigmoid function of the position with the smallest error to represent the function that maps each position to the corresponding number of impressions. The price landscape system may select a different sigmoid function to represent the positions are associated with the same web page of the search results (e.g., a function for positions 1-8 on the first web page and a function for positions 9-16 on the second web page).

If advertiser-specific performance data for the current day does not include this keyword, then the price landscape system derives the number of impressions from the overall price estimation data. The price landscape system also estimates the number of conversions per click for the keyword from the advertiser-specific performance data.

The price landscape system calculates the advertiser-specific statistics that represent the price landscape data for the advertiser. The price landscape system sets a bid for each position as an average of the cost per click for that position and the cost per click of the next better (e.g., lower number) position according to the following equation:

$$Bid ( pos ) = \{ \begin{matrix}[ {CPC}_{A} ( pos - 1 ) + {CPC}_{A} ( pos ) ] / 2 , & if pos > 1 \\ {CPC}_{A} ( 1 ) + ɛ , & if pos = 1\end{matrix} \qquad ( 6 )$$

where Bid(pos) represents the bid that is expected to get the advertisement into position pos and ε represents an increase in bid for the first position. The price landscape system sets a predicted number of clicks for a position as the advertiser's clickthrough rate for the position times the number of impressions for that position as indicated by the following equation:

PredictedClicks(pos)=CTR_{A}(pos)*IM(pos) (7)

The price landscape system sets a predicted cost for a position as the advertiser-specific cost for the position times the predicted number of clicks for that position as represented by the following equation:

PredictedCost(pos)=CPC_{A}(pos)*PredictedClicks(pos) (8)

The price landscape system sets a predicted number of conversions for a position as the number of conversions per click times the predicted clicks for that position as represented by the following equation:

PredictedConv(pos)=conversions per click*PredictedClicks(pos) (9)

One skilled in the art will appreciate that the conversions can be purchase conversions, qualified lead conversions, or any other type or combination of types of conversions that the advertiser is interested in tracking.

In some embodiments, the price landscape data is used to suggest bid amounts for keywords with the goal of optimizing some objective of an advertiser. The price landscape system may include a suggest bid system. The suggest bid system uses as input, for each keyword, collection of bid amount, cost, and utility tuples, referred to as price landscape tuples. The cost represents the total cost over some period of submitting bids for that keyword with the bid amount specified as the maximum amount of a bid. The utility represents the corresponding benefit (e.g., profits, revenue, clicks, or conversions) resulting from placing those bids for the keyword. The suggest bid system may initialize suggested bid amounts for each keyword to zero and repeatedly increase the bid amount by a certain amount for the keyword whose price landscape data indicates that increasing the current bid for that keyword will be more beneficial than increasing the current bid amount for any other keyword. In particular, the suggest bid system may determine that the keyword whose increased bid amount results in the greatest benefit for its cost is the most beneficial. The suggest bid system thus uses a greedy algorithm to increase bid amounts that are locally optimum.

Before setting the bid amounts, the price landscape system may filter out the price landscape tuples for each keyword that would result in sub-optimal bids. For example, one tuple in the price landscape tuples for a keyword may indicate that that a bid of $1.00 results in 10 clickthroughs and another point may indicate that a bid of $2.00 results in 5 clickthroughs. Mathematically, the price landscape data represents tuples on a graph of cost versus utility (or more generally cost versus benefit (e.g., conversions)) with cost represented on the x-axis. For each keyword, the suggest bid system selects the points (corresponding to tuples) of the upper convex hull of the graph as the points, referred to as undominated points, for use in setting the bid amounts. Such undominated points represent the best tradeoff between cost and resulting utility.

In some embodiments, the suggest bid system defines utility as profit for a keyword and a certain bid amount by the following equation:

pᵢⱼ=COST(i,bᵢⱼ)/CPC(i,bᵢⱼ) (10)

where pᵢⱼ represents the profit for keyword i with bid bᵢⱼ. Thus, in this embodiment, the profit represents number of clicks. The suggest bid system defines the weight by the following equation:

wᵢⱼ=COST(i,bᵢⱼ). (11)

where wᵢⱼ represents the weight for keyword i with bid bᵢⱼ.

The suggest bid system initially orders the undominated tuples for each keyword according to increasing cost and initializes the current bid amount for each keyword to zero. The suggest bid system then calculates a slope for each tuple as represented by the following equation:

λᵢⱼ=(pᵢⱼ−pᵢⱼ₋₁)/(wᵢⱼ−wᵢⱼ₋₁) (12)

where i ranges from 1 to the number of keywords and j ranges from 2 to the number of tuples for keyword i. Thus, the slope represents the change in utility per unit cost such that the steeper the slope, the greater the benefit. The suggest bid system then sorts all the tuples for each keyword in non-decreasing slope order. The suggest bid system then processes each tuple in slope order until some termination condition is satisfied. The termination condition may be that the total cost for the bid amounts suggested so far exceeds a budgeted amount, the bid amounts will result in a desired number of clicks, number of conversions, amount of revenue, and so on. When the suggest bid system processes the next tuple in slope order, it changes the suggested bid for the keyword (represented to the processed tuple to the bid amount of the processed tuples) and checks to see whether the termination condition is satisfied.

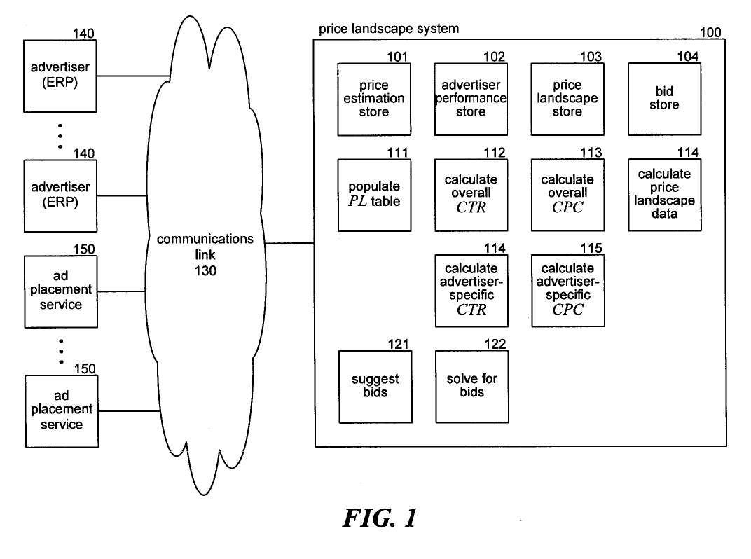

FIG. 1 is a block diagram that illustrates components of the price landscape system in some embodiments. The price landscape system 100 may be connected to advertisers 140 that use an ERP system and advertisement placement services 150 via communication link 130. The price landscape system includes a price estimation store 101, an advertiser performance store 102, a price landscape store 103, and a bid store 104. The price estimation store contains the overall price estimation data, the advertiser performance store contains the advertiser-specific performance data, and the price landscape store contains the generated price landscape data. The bid store contains the suggested bids for keywords. The price landscape system also includes a populate price landscape table component 111, a calculate overall clickthrough rate component 112, a calculate overall cost per click component 113, a calculate advertiser-specific clickthrough rate component 114, a calculate advertiser-specific cost per click component 115, and a calculate price landscape data component 116. Each of these components is described below in detail. The price landscape system also includes a suggest bids component 121 and a solve for bids component 122.

The computing device on which the price landscape system is implemented may include a central processing unit, memory, input devices (e.g., keyboard and pointing devices), output devices (e.g., display devices), and storage devices (e.g., disk drives). The memory and storage devices are computer-readable media that may contain instructions that implement the price landscape system. In addition, the data structures and message structures may be stored or transmitted via a data transmission medium, such as a signal on a communications link. Various communications links may be used, such as the Internet, a local area network, a wide area network, or a point-to-point dial-up connection.

The price landscape system may be implemented or used in various operating environments that include personal computers, server computers, hand-held or laptop devices, multiprocessor systems, microprocessor-based systems, programmable consumer electronics, network PCs, minicomputers, mainframe computers, distributed computing environments that include any of the above systems or devices, and the like.

The price landscape system may be described in the general context of computer-executable instructions, such as program modules, executed by one or more computers or other devices. Generally, program modules include routines, programs, objects, components, data structures, and so on that perform particular tasks or implement particular abstract data types. Typically, the functionality of the program modules may be combined or distributed as desired in various embodiments.

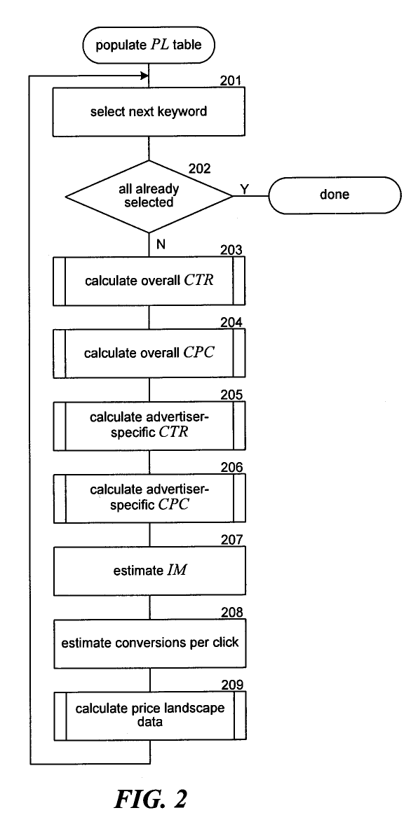

FIG. 2 is a flow diagram that illustrates the processing of the populate price landscape table component in some embodiments. The component generates the price landscape data based on the overall price estimation data and advertiser-specific performance data and stores the landscape data in the price landscape store. In block 201, the component selects the next keyword. In decision block 202, if all the keywords have already been selected, then the component completes, else the component continues at block 203. In block 203, the component invokes the calculate overall clickthrough rate component to calculate the overall clickthrough rate for the overall price estimation data. In block 204, the component invokes the calculate overall cost per click component to calculate the overall cost per click for the selected keyword from the overall price estimation data. In block 205, the component invokes the calculate advertiser-specific clickthrough rate component to calculate a clickthrough rate for the selected keyword for the advertiser. In block 206, the component invokes the calculate advertiser-specific cost per click component to calculate a cost per click for the selected keyword. In block 207, the component estimates the number of impressions for the selected keyword. In block 208, the component estimates the conversions per click for the selected keyword. In block 209, the component invokes the calculate price landscape data component to calculate the price landscape data for the selected keyword and adds the calculated data to the price landscape store. The component then loops to block 201 to select the next keyword.

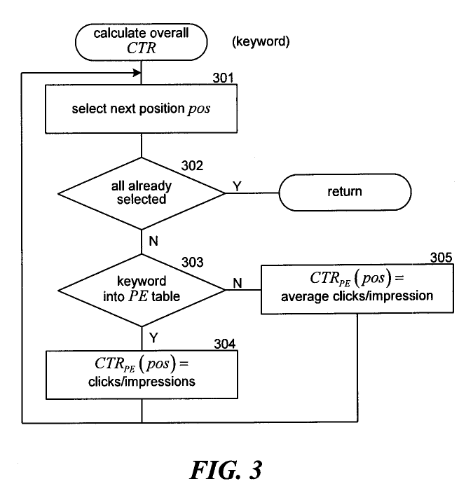

FIG. 3 is a flow diagram that illustrates the processing of the calculate overall clickthrough rate component in some embodiments. The component is passed a keyword and calculates an overall clickthrough rate for that keyword. In block 301, the component selects the next position. In block 302, if all the positions have already been selected, then the component returns the calculated clickthrough rate for each position, else the component continues at block 303. In decision block 303, if the overall price estimation data includes the passed keyword, then the component continues at block 304, else the component continues at block 305. In block 304, the component sets the overall clickthrough rate for the selected position based on the overall price estimation data. In block 305, the component sets the overall clickthrough rate for the selected position based on the average data of the advertiser-specific performance data. The component then loops to block 301 to select the next position.

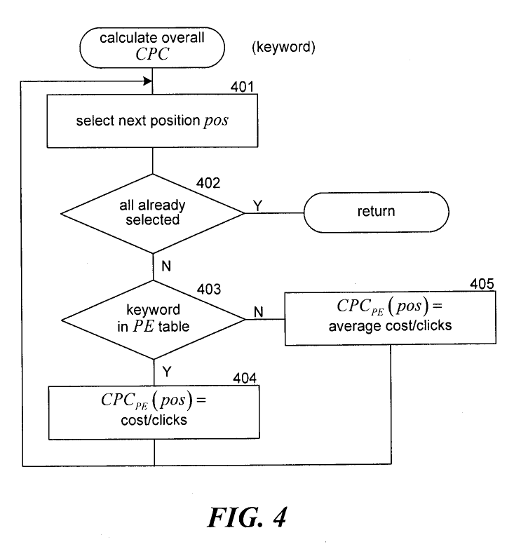

FIG. 4 is a flow diagram that illustrates the processing of the calculate overall cost per click component in some embodiments. The component is passed a keyword and calculates an overall cost per click for that keyword. In block 401, the component selects the next position. In block 402, if all the positions have already been selected, then the component returns the calculated cost per click for each position, else the component continues at block 403. In decision block 403, if the overall price estimation data includes the passed keyword, then the component continues at block 404, else the component continues at block 405. In block 404, the component sets the overall cost per click for the selected position based on the overall price estimation data. In block 405, the component sets the overall cost per click for the selected position based on the average data of the advertiser-specific performance data. The component then loops to block 401 to select the next position.

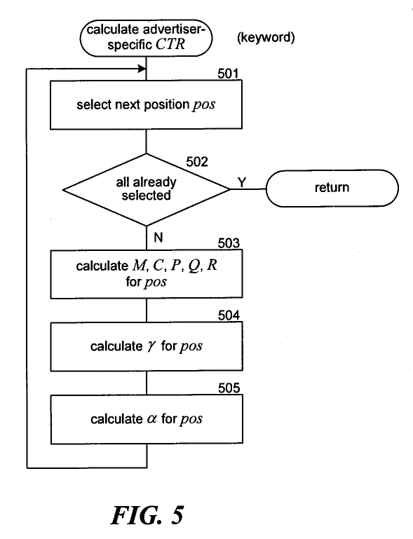

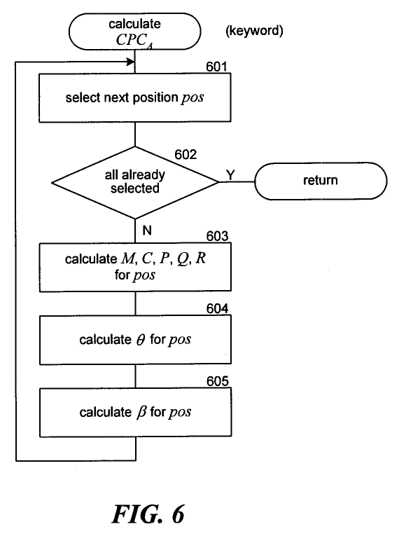

FIG. 5 is a flow diagram that illustrates the processing of the calculate advertiser-specific clickthrough rate component in some embodiments. The component is passed a keyword and generates a function that fits historical advertiser-specific performance data to historical overall price estimation data. In block 501, the component selects the next position. In decision block 502, if all the positions have already been selected, then the component returns, else the component continues at block 503. In block 503, the component calculates the values of Equation 2. In blocks 504 and 505, the component calculates the curve-fitting parameters using Equations 3 and 4. The component then loops to block 501 to select the next position. FIG. 6 is a flow diagram that illustrates the processing of the calculate advertiser-specific cost per click component in some embodiments. The component performs processing analogous to that explained for FIG. 5 except it calculates cost per click rather than clickthrough rate.

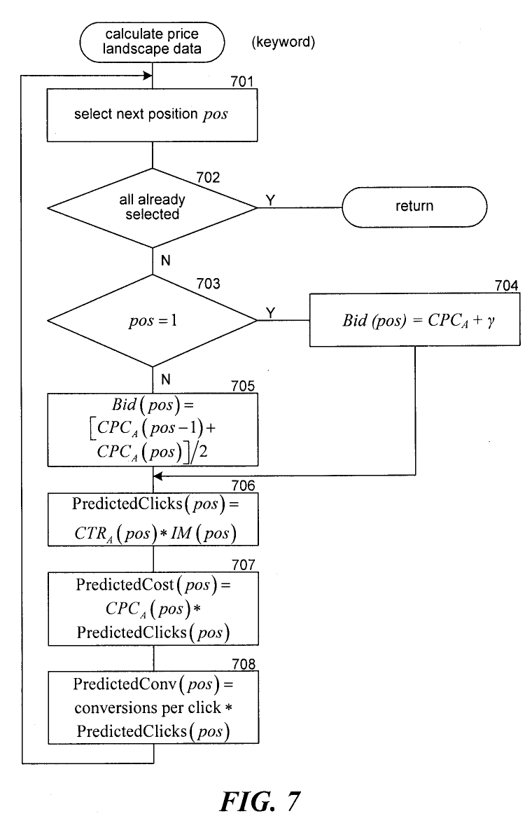

FIG. 7 is a flow diagram that illustrates the processing of the calculate price landscape data component in some embodiments. The component is passed a keyword and calculates the price landscape data for that keyword. In block 701, the component selects the next position. In decision block 702, if all the positions have already been selected, then the component returns, else the component continues at block 703. In decision block 703, if the selected position is the first position, then the component continues at block 704, else the component continues at block 705. In blocks 704 and 705, the component calculates the bid amount for the selected position according to Equation 7. In block 706, the component calculates the predicted number of clicks for the selected position according to Equation 8. In block 707, the component calculates the predicted cost for the selected position according to Equation 9. In block 708, the component calculates the predicted number of conversions for the selected position according to Equation 10. The component then loops to block 701 to select the next position.

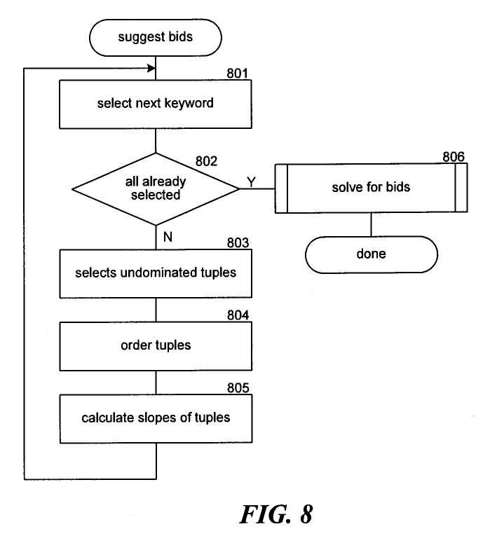

FIG. 8 is a flow diagram that illustrates the processing of the suggest bids component in some embodiments. The component suggests a bid for each keyword based on the price landscape tuples the include bid amount, cost, and utility. In block 801, the component selects the next keyword. In decision block 802, if all the keywords have already been selected, then the component continues at block 806, else the component continues at block 803. In block 803, the component selects the undominated tuples for the selected keyword. In block 804, the component sorts the undominated tuples based on cost. In block 805, the component calculates a slope of the sorted tuples. The component then loops to block 801 to select the next keyword. In block 806, the component invokes the solve for bids component and then completes.

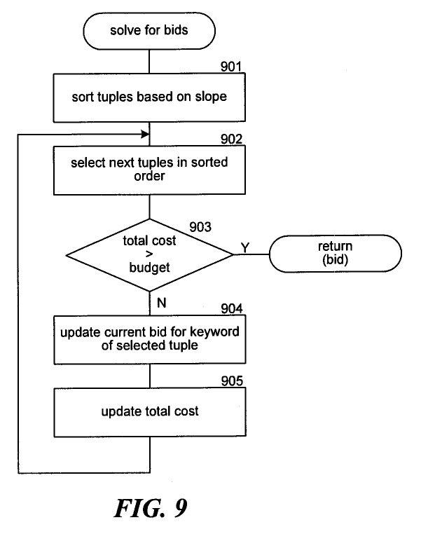

FIG. 9 is a flow diagram that illustrates the processing of the solve for bids component in some embodiments. The component sets a bid amount for each keyword based on the slopes associated with the tuples of that keyword. In block 901, the component sorts the tuples based on non-decreasing order of their slopes. The component initially sets the current bid amount for each keyword to zero. The component may need to increase initial non-zero bid amounts so that they satisfy the minimum bid amount of an advertisement placement service. In blocks 902-905, the component loops selecting the tuples in a slope order and resetting the current bid amount for the corresponding keyword. In block 902, the component selects the next tuple in sorted slope order. In decision block 903, if an objective function is satisfied, such as the total cost based on the current bid amounts exceeds a budgeted cost, then the component returns the current bid amounts, else the component continues at block 904. One skilled in the art will appreciate that other objective functions may be used such as those based on total profit, number of clicks, number of conversions, and so on. In block 904, the component updates the current bid amount for the keyword to the bid amount of the selected tuple. In block 905, the component updates the total cost for submitting bids at the current bid amount and then loops to block 902 to select the next point.

Although the subject matter has been described in language specific to structural features and/or methodological acts, it is to be understood that the matter defined in the appended claims is not necessarily limited to the specific features or acts described above. For example, the overall price estimation data and the advertiser-specific performance data may further divide keyword data based on match type of a bid and the advertiser's specific campaign. Each bid for placement of an advertisement may specify the type of match needed between the keyword and the query of a search engine. One match type may specify that the keyword (which may be a phrase) must occur in the query in that exact order for a match. Another match type may specify that the ordering is unimportant. The suggest bid component can be adapted to specify tuples for each keyword and match type combination. In such a case, the suggest bids component will reset the current bid amount for the keyword and match type combination with the steepest slope (e.g., utility/cost). One skilled in the art will also appreciate that the suggest bid component may use various target statistics as an effectiveness measure, when selecting the next tuple for setting the next bid amount. For example, the component may use profit per click, conversions per click, and so on. Accordingly, the invention is not limited except as by the appended claims.

I/We claim:

1. A method in a computing device for generating a price landscape for an advertiser for bids placed for advertisement space, the method comprising:
providing overall price estimation data that includes, for keyword and bid amount combinations, number of clicks, cost, and number of impressions;
providing advertiser-specific performance data that includes, for each keyword, number of clicks, cost, number of impressions, and average cost per click; and
for each keyword,
calculating a clickthrough rate for the keyword based on a clickthrough rate derived from the provided overall price estimation data and a clickthrough rate derived from the provided advertiser-specific performance data;
calculating a cost per click for the keyword based on a cost per click derived from the provided overall price estimation data and a cost per click derived from the provided advertiser-specific performance data;
estimating a number of impressions for the keyword from the data;
estimating a conversions per click for the keyword from the advertiser-specific performance data; and
calculating advertiser-specific statistics including bid amount, predicted number of clicks, predicted cost, and predicted conversions from the calculated clickthrough rate, calculated cost per click, estimated number of impressions, and estimated conversions per click.

2. The method of claim 1 wherein the advertiser-specific statistics are calculated for each advertisement position.

3. The method of claim 2 wherein the overall price estimation data includes an advertisement position.

4. The method of claim 2 wherein the advertiser-specific performance data includes average advertisement position.

5. The method of claim 1 including calculating bid amounts for keywords for the advertiser based on analysis of the advertiser-specific statistics.

6. The method of claim 5 wherein the calculating of bid amounts includes:
for each keyword, calculating a rate of change of a target statistic for the keyword based on different predicted costs; and
determining a bid amount for each keyword by setting an initial bid amount for each keyword to zero; and
repeatedly selecting the keyword with the next highest rate of change and resetting the bid amount for that keyword based on the rate of change until an objective function is satisfied.

7. The method of claim 1 wherein the calculating of the clickthrough rate for the keyword is based on the following:
CTR_{A}(pos)=min(γ+αCTR_{PE}(pos),0)
where CTR_{A}(pos) represents the calculated advertiser-specific clickthrough rate when the advertisement position is pos, CTR_{PE}(pos) represents an overall clickthrough rate derived from overall price estimation data, and γ and α represent parameters derived from fitting advertiser-specific performance data to overall price estimation data.

8. The method of claim 1 where the calculating of a cost per click for the keyword is based on the following:
CPC_{A}(pos)=min(θ+βCPC_{PE}(pos),0)
where CPC_{A}(pos) represents the calculated advertiser-specific cost per click when the advertisement position is pos, CPC_{PE}(pos) represents the cost per click derived from the overall price estimation data, and θ and β represent parameters derived from fitting advertiser-specific performance data to overall price estimation data.

9. A computer-readable storage medium storing instructions for controlling a computing device to generate a price landscape for an advertiser for bids placed for advertisement space, by a method comprising:
providing overall price estimation data for keyword, advertisement position, and bid amount combinations that are aggregated from multiple advertisers;
providing advertiser-specific performance data for keyword and advertisement position combinations that are specific to the advertiser; and
for each keyword and advertisement position,
calculating a clickthrough rate for the keyword and position based on a clickthrough rate derived from the provided overall price estimation data;
calculating a cost per click for the keyword and position based on a cost per click derived from the provided overall price estimation data;
estimating a number of impressions for the keyword from the data;
estimating a conversions per click for the keyword from the advertiser-specific performance data; and
calculating advertiser-specific statistics from the calculated clickthrough rate, calculated cost per click, estimated number of impressions, and estimated conversions per click
wherein the calculated advertiser-specific statistics represent a price landscape for the advertiser.

10. The computer-readable medium of claim 9 wherein the overall price estimation data includes, for keyword, advertisement position, and bid amount combinations, number of clicks, cost, and number of impressions, and wherein the advertiser-specific performance data includes, for a keyword, average advertisement position, number of clicks, cost, number of impressions, and average cost per click.

11. The computer-readable medium of claim 10 wherein the advertiser-specific statistics include bid amount, predicted number of clicks, predicted cost, and predicted conversions from the calculated clickthrough rate, calculated cost per click, estimated number of impressions, and estimated conversions per click.

12. The computer-readable medium of claim 9 wherein the calculated clickthrough rate is based on a function that applies advertiser-specific parameters to the overall price estimation data.

13. The computer-readable medium of claim 12 wherein the parameters are calculated based on a weighted least-squares fit of advertiser-specific performance data to overall price estimation data.

14. The computer-readable medium of claim 9 including calculating bid amounts for keywords for the advertiser based on analysis of the price landscape for the advertiser.

15. The computer-readable medium of claim 14 wherein the calculating of bid amounts includes setting an initial bid amount for each keyword and repeatedly increasing the bid amount for that keyword whose rate of change of a target statistic for the keyword based on different predicted costs is greatest.

16. A computer-readable storage medium storing instructions for controlling a computing device to calculate bid amounts for placing advertisements of an advertiser, by a method comprising:
providing a price landscape indicating, for each of a plurality of bid amounts for each of a plurality of keywords, an effectiveness measure associated with the bid amount and keyword, the effectiveness measure being based on statistics indicating leads resulting from placement of an advertisement with the keyword that are qualified; and
calculating a bid amount for each of the keywords by setting an initial bid amount for each keyword; and
repeatedly increasing the bid amount for that keyword whose rate of change of a target statistic derived from qualified leads for the keyword based on cost is greatest.

17. The computer-readable storage medium of claim 16 wherein the providing of a pricing landscape includes:
providing overall price estimation data that includes, for keyword, advertisement position, and bid amount combinations, number of leads, cost, and number of impressions; and
providing advertiser-specific performance data that includes, for keywords, an average advertisement position, number of leads, cost, number of impressions, number of qualified leads, and average cost per click.

18. The computer-readable storage medium of claim 17 wherein the price landscape includes bid amount, predicted number of leads, predicted cost, and predicted number of qualified leads from the calculated clickthrough rate, calculated cost per click, estimated number of qualified leads, and estimated qualified leads per click.

19. The computer-readable storage medium of claim 16 wherein the calculating of the bid amount includes
for keyword and advertisement position combinations,
ordering bid data points based on increasing cost; and
calculating a rate of change based on profit and cost by comparing bid data points that are adjacent based on the ordering; and
ordering the bid data points based on the calculated rate of change wherein the bid amount is next increased for the keyword whose bid data point is next in bid data points ordered based on the calculated rate of change.

20. The computer-readable storage medium of claim 19 including, prior to ordering the bid data points based on increasing cost per click, removing bid data points that are dominated by other bid data points.
